(19) United States
(12) Patent Application Publication
(10) Pub. No.: US 2023/0312011 A1
(43) Pub. Date: Oct. 5, 2023

(54) VEHICLE BODY REAR PART STRUCTURE

(71) Applicant: Honda Motor Co., Ltd., Tokyo (JP)

(72) Inventor: Shinya TANABE, Tokyo (JP)

(73) Assignee: Honda Motor Co., Ltd., Tokyo (JP)

(21) Appl. No.: 18/179,349

(22) Filed: Mar. 6, 2023

(30) Foreign Application Priority Data
Mar. 31, 2022 (JP) 2022-060090

(51) Int. Cl. B62D 25/16; B62D 25/04

(52) U.S. Cl. CPC B62D 25/16; B62D 25/04; B60J 1/08

(57) ABSTRACT

A vehicle body rear part structure includes a rear side inner panel which constitutes a part of an opening provided at a rear part of a vehicle body and is joined to a rear pillar. The rear side inner panel includes a skeleton part extending in a front-rear direction of the vehicle body. The skeleton part is formed so that a cross-sectional shape when cut perpendicularly to a longitudinal direction of the skeleton part protrudes in a vehicle width direction.

### CROSS-REFERENCE TO RELATED APPLICATION

This application claims the priority benefit of Japan application serial no. 2022-060090, filed on Mar. 31, 2022. The entirety of the above-mentioned patent application is hereby incorporated by reference herein and made a part of this specification.

### BACKGROUND

### Technical Field

The disclosure relates to a vehicle body rear part structure, and more particularly, to a vehicle body rear part structure including a rear side inner panel.

### Related Art

In some vehicles, a rear side inner panel that forms a vehicle body side part is arranged between a center pillar and a rear wheelhouse of a vehicle body as a structure (vehicle body rear part structure) of a vehicle body rear part of the vehicle. For example, the technique disclosed in Patent Document 1 (Japanese Patent Application Laid-Open No. 2009-190548) is known as such a vehicle body rear part structure.

In the vehicle body rear part structure (hereinafter referred to as “conventional art” in this specification) disclosed in Patent Document 1, a center pillar is arranged on the front side of a rear wheelhouse at a predetermined interval, and a side opening is formed in the rear side inner panel between the center pillar and the rear wheelhouse (see FIG. 3 of Patent Document 1). The side opening is formed to reduce the weight of the rear side inner panel and the weight of the vehicle body.

At the side opening, a mounting bracket is attached to the rear side inner panel to cross the side opening, and a speaker is attached to this mounting bracket (see FIG. 3 of Patent Document 1).

In the above conventional art, to ensure the rigidity of the rear side inner panel, in the case where the rear side inner panel is enlarged by, for example, forming the rear side inner panel to extend to the rear side of the vehicle body, vibration is likely to occur in the rear side inner panel.

Therefore, in the conventional art, as described above, since vibration is likely to occur in the rear side inner panel, it is difficult to suppress noise caused by such vibration.

### SUMMARY

In an embodiment of the disclosure, a vehicle body rear part structure includes a rear side inner panel which forms a part of a rear wheelhouse. The rear side inner panel constitutes a part of an opening provided at a vehicle body rear part and is joined to a rear pillar extending in an up-down direction of a vehicle body. The rear side inner panel includes a skeleton part extending in a front-rear direction of the vehicle body.

According to the embodiment of the disclosure, since the rear side inner panel arranged from the rear wheelhouse to the rear pillar is provided with the skeleton part extending in the front-rear direction of the vehicle body, it is possible to suppress film surface deformation of the rear side inner panel and suppress occurrence of vibration of the rear side inner panel and noise caused by this vibration. Further, since the skeleton part enables load transmission between the rear wheelhouse and the rear pillar, the rigidity of the rear side inner panel can be improved. Therefore, vibration of the rear side inner panel and noise caused by this vibration can be suppressed while ensuring the rigidity of the rear side inner panel.

### BRIEF DESCRIPTION OF THE DRAWINGS

FIG. 1 is a front view of a state of a rear part of a vehicle body viewed from a rear side, showing a configuration of a vehicle body rear part structure according to an embodiment of the disclosure.

FIG. 2 is a side view showing a state of the rear part of the vehicle body viewed from a vehicle width direction outer side.

FIG. 3 is a side view showing a state of the rear part of the vehicle body viewed from a vehicle width direction inner side.

FIG. 4 is a side view showing a rear side inner panel shown in FIG. 2.

FIG. 5 is a perspective view showing a state of the rear side inner panel viewed from the vehicle width direction inner side when the rear part of the vehicle body is cut along line A-A in FIG. 3.

FIG. 6 is an enlarged perspective view of the vicinity of a skeleton part of the rear side inner panel shown in FIG. 5.

FIG. 7 is a view of a cross section taken along line B-B in FIG. 3, illustrating an inner surface shape of an outer wall of the skeleton part.

FIG. 8 is a side view showing a state of the rear part of the vehicle body viewed from the vehicle width direction inner side, illustrating load transmission by a first load transmission part, a second load transmission part, and a third load transmission part.

### DESCRIPTION OF THE EMBODIMENTS

An embodiment of the disclosure provides a vehicle body rear part structure capable of suppressing vibration of a rear side inner panel and noise caused by this vibration while ensuring the rigidity of the rear side inner panel, to suppress decrease in smoothness of traffic of vehicles while improving the safety of traffic.

In Invention 1 of the disclosure, a vehicle body rear part structure includes a rear side inner panel which forms a part of a rear wheelhouse. The rear side inner panel constitutes a part of an opening provided at a vehicle body rear part and is joined to a rear pillar extending in an up-down direction of a vehicle body. The rear side inner panel includes a skeleton part extending in a front-rear direction of the vehicle body.

In Invention 2 of the disclosure, the skeleton part is formed so that a cross-sectional shape when cut perpendicularly to a longitudinal direction of the skeleton part protrudes in a vehicle width direction.

In Invention 3 of the disclosure, a window is formed at a side part of the vehicle body rear part by the vehicle body and the rear side inner panel. The skeleton part extends in the front-rear direction of the vehicle body along a lower end part of the window.

In Invention 4 of the disclosure, the skeleton part is formed so that a cross-sectional depth of the skeleton part when cut in the vehicle width direction along the longitudinal direction of the skeleton part increases toward a longitudinal middle part of the skeleton part.

In Invention 5 of the disclosure, the rear side inner panel is integrally formed with a wheelhouse outer which constitutes a vehicle width direction outer side of the rear wheelhouse. The rear wheelhouse includes a wheelhouse inner which constitutes a vehicle width direction inner side of the rear wheelhouse. A lower end part of a quarter pillar extending in the up-down direction of the vehicle body is connected to an upper end part side of the wheelhouse inner, and the quarter pillar is arranged at a predetermined interval with the rear pillar in the front-rear direction of the vehicle body. The skeleton part extends from the quarter pillar to the rear pillar.

In Invention 6 of the disclosure, the rear side inner panel includes a plurality of openings, and includes a plurality of load transmission parts formed around each of the openings.

In Invention 7 of the disclosure, the load transmission parts include a first load transmission part extending from an upper end part and a lower end part of the rear wheelhouse toward a longitudinal middle part side of the rear pillar.

In Invention 8 of the disclosure, the load transmission parts include a pair of second load transmission parts. One of the second load transmission parts extends from the upper end part of the rear wheelhouse to an upper end part of the rear pillar, and another of the second load transmission parts extends from the lower end part of the rear wheelhouse to a lower end part of the rear pillar.

In Invention 9 of the disclosure, the load transmission parts include a third load transmission part which is formed along a longitudinal direction of the rear pillar and connects the first load transmission part and the second load transmission parts.

According to Invention 1 of the disclosure, since the rear side inner panel arranged from the rear wheelhouse to the rear pillar is provided with the skeleton part extending in the front-rear direction of the vehicle body, it is possible to suppress film surface deformation of the rear side inner panel and suppress occurrence of vibration of the rear side inner panel and noise caused by this vibration. Further, since the skeleton part enables load transmission between the rear wheelhouse and the rear pillar, the rigidity of the rear side inner panel can be improved. Therefore, vibration of the rear side inner panel and noise caused by this vibration can be suppressed while ensuring the rigidity of the rear side inner panel.

According to Invention 2 of the disclosure, since it is possible to suppress film surface deformation of the rear side inner panel without using a reinforcing member such as a bracket by forming the cross-sectional shape of the skeleton part when cut perpendicularly to the longitudinal direction of the skeleton part to protrude toward the vehicle width direction, it is possible to suppress occurrence of vibration of the rear side inner panel and noise caused by this vibration without using a reinforcing member such as a bracket. Further, since the skeleton part enables load transmission between the rear wheelhouse and the rear pillar, the rigidity of the rear side inner panel can be improved. Therefore, vibration of the rear side inner panel and noise caused by this vibration can be suppressed while ensuring the rigidity of the rear side inner panel.

According to Invention 3 of the disclosure, since the skeleton part is provided to extend in the front-rear direction of the vehicle body along the lower end part of the window, by configuring the skeleton part along the lower end part of the window, it is possible to improve the rigidity around the window which forms an opening, and it is possible to effectively suppress film surface deformation of the rear side inner panel. Therefore, vibration of the rear side inner panel and noise caused by this vibration can be further suppressed while ensuring the rigidity of the rear side inner panel.

According to Invention 4 of the disclosure, since the cross-sectional depth of the skeleton part when cut in the vehicle width direction along the longitudinal direction of the skeleton part is formed to increase toward the longitudinal middle part of the skeleton part, a load inputted to the rear side inner panel can be efficiently transmitted to the skeleton part, and the rigidity of the rear side inner panel can be further improved. As a result, it is possible to further suppress film surface deformation of the rear side inner panel and suppress occurrence of vibration of the rear side inner panel and noise caused by this vibration. Therefore, vibration of the rear side inner panel and noise caused by this vibration can be further suppressed while ensuring the rigidity of the rear side inner panel.

According to Invention 5 of the disclosure, since the skeleton part connects the quarter pillar and the rear pillar, a load inputted to the rear side inner panel can be transmitted to the quarter pillar and the rear pillar via the skeleton part, and the rigidity of the rear side inner panel can be improved. As a result, it is possible to further suppress film surface deformation of the rear side inner panel and suppress occurrence of vibration of the rear side inner panel and noise caused by this vibration. Therefore, vibration of the rear side inner panel and noise caused by this vibration can be further suppressed while ensuring the rigidity of the rear side inner panel.

According to Invention 6 of the disclosure, since the load transmission part is provided around each of the plurality of openings provided at the rear side inner panel, an inputted load can be transmitted via the load transmission part while reducing the weight of the rear side inner panel. As a result, it is possible to reduce the weight of the rear side inner panel while ensuring the rigidity of the rear side inner panel.

According to Invention 7 of the disclosure, since the first load transmission part is provided to extend from the upper end part and the lower end part of the rear wheelhouse toward the longitudinal middle part side of the rear pillar, a load inputted to the rear side inner panel can be efficiently transmitted, and the rigidity of the rear side inner panel can be improved. As a result, it is possible to further suppress film surface deformation of the rear side inner panel and suppress occurrence of vibration of the rear side inner panel and noise caused by this vibration. Therefore, vibration of the rear side inner panel and noise caused by this vibration can be further suppressed while ensuring the rigidity of the rear side inner panel.

According to Invention 8 of the disclosure, by providing the second load transmission part extending respectively from the upper end part and the lower end part of the rear wheelhouse to the upper end part and the lower end part of the rear pillar, a load inputted to the rear side inner panel can be efficiently transmitted, and the rigidity of the rear side inner panel can be improved. As a result, it is possible to further suppress film surface deformation of the rear side inner panel and suppress occurrence of vibration of the rear side inner panel and noise caused by this vibration. Therefore, vibration of the rear side inner panel and noise caused by this vibration can be further suppressed while ensuring the rigidity of the rear side inner panel.

According to Invention 9 of the disclosure, by providing the third load transmission part which connects the first load transmission part and the second load transmission part, not only a load inputted in the front-rear direction of the vehicle body, but also a load in the up-down direction of the vehicle body inputted to the first load transmission part and the second load transmission part can be transmitted. As a result, deformation of the first load transmission part and the second load transmission part can be suppressed. Therefore, vibration of the rear side inner panel and noise caused by this vibration can be further suppressed while ensuring the rigidity of the rear side inner panel.

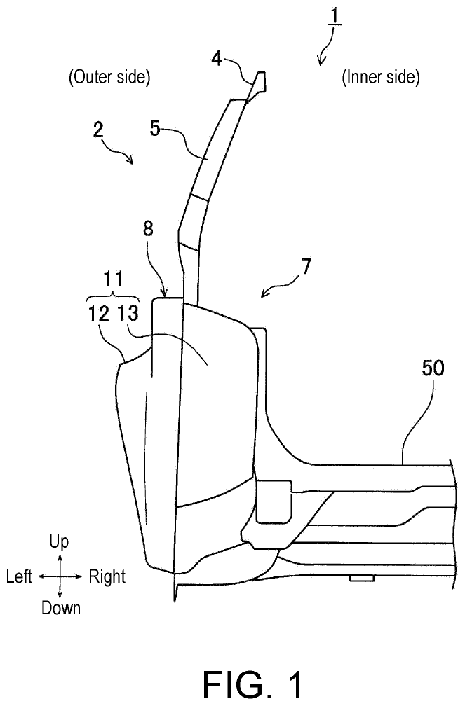

Hereinafter, an embodiment of a vehicle body rear part structure according to the disclosure will be described with reference to FIG. 1 to FIG. 8.

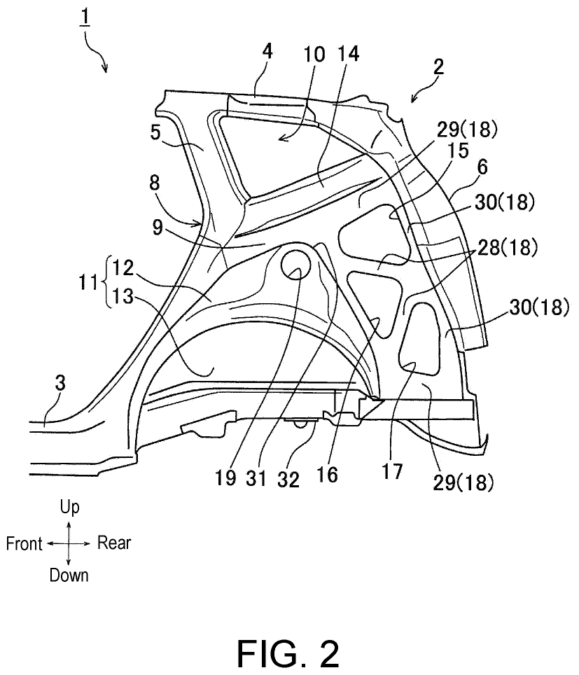

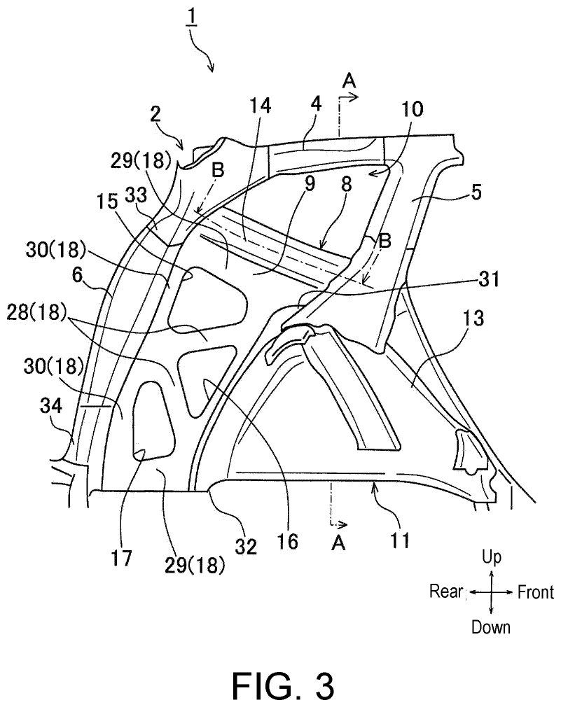

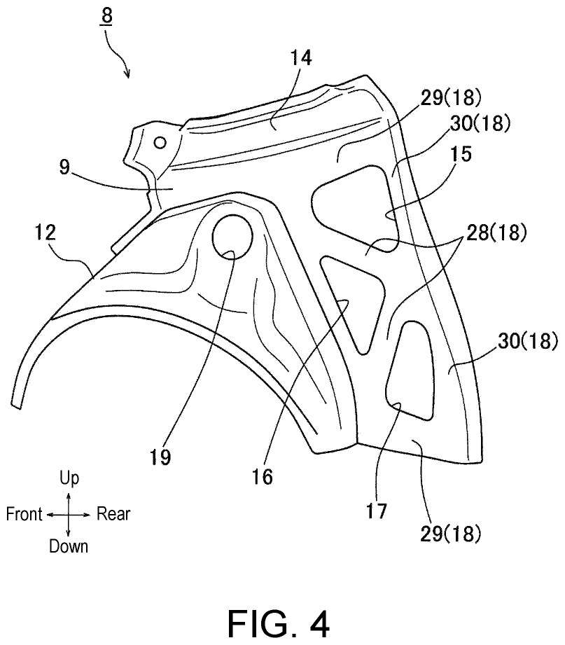

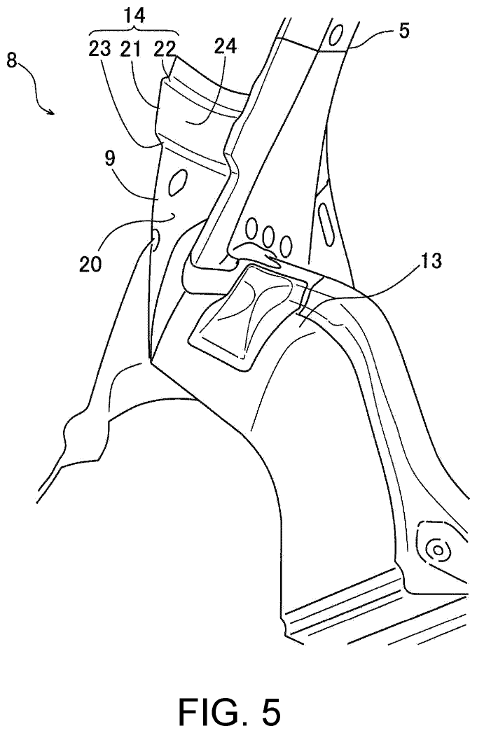

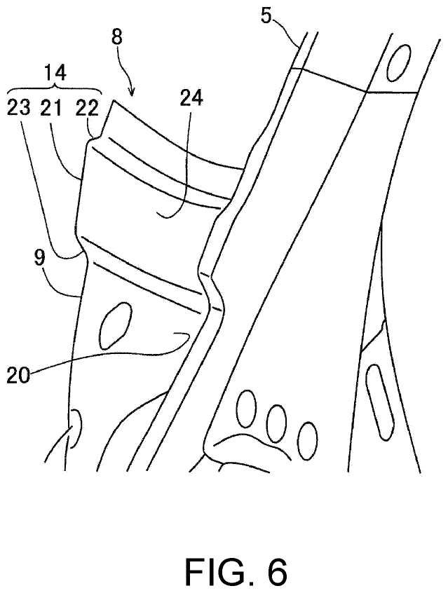

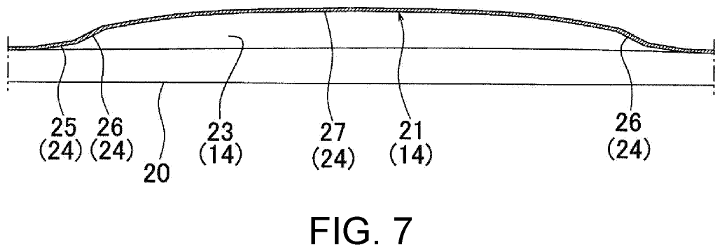

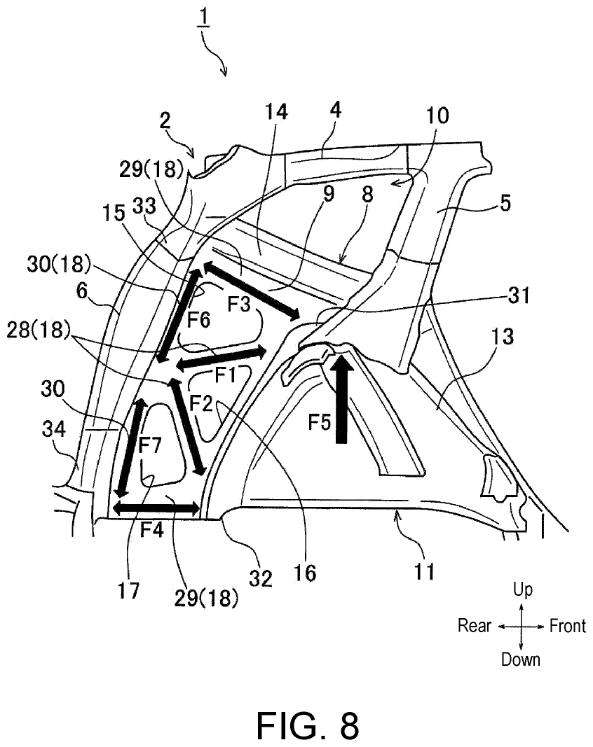

FIG. 1 is a front view of a state of a rear part of a vehicle body viewed from a rear side, showing a configuration of a vehicle body rear part structure according to an embodiment of the disclosure. FIG. 2 is a side view showing a state of the rear part of the vehicle body viewed from a vehicle width direction outer side. FIG. 3 is a side view showing a state of the rear part of the vehicle body viewed from a vehicle width direction inner side. FIG. 4 is a side view showing a rear side inner panel shown in FIG. 2. FIG. 5 is a perspective view showing a state of the rear side inner panel viewed from the vehicle width direction inner side when the rear part of the vehicle body is cut along line A-A in FIG. 3. FIG. 6 is an enlarged perspective view of the vicinity of a skeleton part of the rear side inner panel shown in FIG. 5. FIG. 7 is a view of a cross section taken along line B-B in FIG. 3, illustrating an inner surface shape of an outer wall of the skeleton part. FIG. 8 is a side view showing a state of the rear part of the vehicle body viewed from the vehicle width direction inner side, illustrating load transmission by a first load transmission part, a second load transmission part, and a third load transmission part.

The arrows in the drawings respectively indicate the up-down direction, the left-right direction, and the front-rear direction (the directions of the arrows are exemplary).

In this embodiment, a case where the vehicle body rear part structure according to the disclosure is applied as a structure of a rear part 2 of a vehicle body 1 illustrated in FIG. 1 in a vehicle will be described.

In FIG. 2, reference sign 3 indicates a “side sill”, reference sign 4 indicates a “roof side rail”, reference sign 5 indicates a “quarter pillar”, and reference sign 6 indicates a “rear pillar”, and in FIG. 1, reference sign 7 indicates an “interior”.

Herein, as illustrated in FIG. 2 and FIG. 3, the quarter pillar 5 and the rear pillar 6 are respectively arranged at a predetermined interval in the front-rear direction of the vehicle body 1 in the rear part 2 of the vehicle body 1, and are formed to extend in the up-down direction of the vehicle body 1.

As illustrated in FIG. 1 to FIG. 3, the rear part 2 of the vehicle body 1 includes a rear side inner panel 8 at its side part. The rear side inner panel 8 is a member that forms a side wall in the rear part 2 of the vehicle body 1 and forms a part of an opening 50 (see FIG. 1) provided at the rear part 2 of the vehicle body 1. The rear side inner panel 8 is arranged across the quarter pillar 5 and the rear pillar 6 and is joined to the quarter pillar 5 and the rear pillar 6.

By arranging the rear side inner panel 8 as described above, a window 10 is formed at the side part of the rear part 2 of the vehicle body 1 by the roof side rail 4, the quarter pillar 5, and the rear pillar 6 of the vehicle body 1, and an upper end part of the rear side inner panel 8. Although not shown, glass is attached to the window 10.

The rear side inner panel 8 illustrated in FIG. 1 to FIG. 4 includes a main body part 9 and a wheelhouse outer 12 that is continuous with and integrally formed with the main body part 9. The main body part 9 includes a skeleton part 14, openings 15, 16, and 17, and a load transmission part 18. Each configuration of the rear side inner panel 8 according to this embodiment will be described below.

First, the wheelhouse outer 12 will be described. As illustrated in FIG. 1 to FIG. 3, the wheelhouse outer 12 is formed as a portion that constitutes a vehicle width direction outer side of a rear wheelhouse 11. The wheelhouse outer 12 is formed with a working hole 19 (see FIG. 2 and FIG. 4) into which an operator inserts his/her hand during assembly work of the vehicle body 1.

As illustrated in FIG. 1 and FIG. 2, the rear wheelhouse 11 includes a wheelhouse inner 13 that constitutes a vehicle width direction inner side of the rear wheelhouse 11. A lower end part of the quarter pillar 5 is connected to an upper end part side of the wheelhouse inner 13.

Next, the skeleton part 14 will be described. The skeleton part 14 illustrated in FIG. 2 to FIG. 4 is arranged at the upper end part of the rear side inner panel 8 and extends from the quarter pillar 5 to the rear pillar 6 along the front-rear direction of the vehicle body 1.

Since the skeleton part 14 is arranged and formed at the rear side inner panel 8 as described above, as illustrated in FIG. 2 and FIG. 3, the skeleton part 14 extends in the front-rear direction of the vehicle body 1 along a lower end part of the window 10.

As illustrated in FIG. 2 and FIG. 4, the skeleton part 14 is formed to protrude from the main body part 9 toward the vehicle width direction outer side. As illustrated in FIG. 5 and FIG. 6, the skeleton part 14 in this embodiment is formed so that a cross-sectional shape when cut perpendicularly to the longitudinal direction of the skeleton part 14 protrudes (substantially U-shape) toward the vehicle width direction outer side.

As illustrated in FIG. 5 and FIG. 6, the skeleton part 14 includes an outer wall 21, an upper wall 22, and a lower wall 23. The outer wall 21 is formed as an outermost wall part in the vehicle width direction of the skeleton part 14. The upper wall 22 is formed so that one end is continuous with an upper end part of the outer wall 21 and another end extends toward the vehicle width direction inner side and is continuous with the main body part 9. The lower wall 23 is formed so that one end is continuous with a lower end part of the outer wall 21 and another end extends toward the vehicle width direction inner side and is continuous with the main body part 9.

In the case where the skeleton part 14 is cut in the vehicle width direction along the longitudinal direction of the skeleton part 14, and the distance between an inner surface 20 of the main body part 9 and an inner surface 24 of the outer wall 21 of the skeleton part 14 is defined as a “cross-sectional depth” (or “cross-sectional height”) of the skeleton part 14, the cross-sectional depth (or cross-sectional height) of the skeleton part 14 is formed to increase from one longitudinal end and another longitudinal end of the skeleton part 14 toward a longitudinal middle part of the skeleton part 14.

In this embodiment, as illustrated in FIG. 7, the inner surface 24 of the outer wall 21 is formed to gradually incline toward the vehicle width direction outer side away from the main body part 9 toward the longitudinal middle part of the skeleton part 14.

More specifically, as illustrated in FIG. 7, the inner surface 24 of the outer wall 21 includes a first inclined surface 25, a step 26, and a second inclined surface 27. The first inclined surface 25 is formed to gradually incline toward the vehicle width direction outer side away from the main body part 9, respectively from the one longitudinal end and the another longitudinal end of the skeleton part 14 toward the longitudinal middle part of the skeleton part 14.

The second inclined surface 27 is formed via the step 26 which is continuous with the first inclined surface 25 and inclines more greatly toward the vehicle width direction outer side than the first inclined surface 25, and the second inclined surface 27 is formed to gradually incline toward the vehicle width direction outer side away from the main body part 9 toward the longitudinal middle part of the skeleton part 14.

Next, the openings 15, 16, and 17 will be described. The openings 15, 16, and 17 are formed to reduce the weight of the rear side inner panel 8 to achieve weight reduction, and, as will be described later, are configured to be surrounded by the load transmission part 18. As illustrated in FIG. 2 to FIG. 4, the openings 15, 16, and 17 are formed at the main body part 9 of the rear side inner panel 8 to be arranged along the up-down direction of the vehicle body 1.

Next, the load transmission part 18 will be described. As will be described below, the load transmission part 18 is composed of a plurality (three in this embodiment) of load transmission parts, and is formed around each of the openings 15, 16, and 17. As illustrated in FIG. 2 to FIG. 4, the load transmission part 18 includes a first load transmission part 28, a second load transmission part 29, and a third load transmission part 30.

A pair (two) of the first load transmission parts 28 are formed in this embodiment. As illustrated in FIG. 2 and FIG. 3, one first load transmission part 28 extends from an upper end part 31 of the rear wheelhouse 11 and another first load transmission part 28 extends from a lower end part 32 of the rear wheelhouse 11, respectively toward a longitudinal (up-down direction) middle part side of the rear pillar 6.

A pair (two) of the second load transmission parts 29 are formed in this embodiment. As illustrated in FIG. 2 and FIG. 3, one second load transmission part 29 extends from the upper end part 31 of the rear wheelhouse 11 to an upper end part 33 (see FIG. 3) of the rear pillar 6, and another second load transmission part 29 extends from the lower end part 32 of the rear wheelhouse 11 to a lower end part 34 (see FIG. 3) of the rear pillar 6.

A pair (two) of the third load transmission parts 30 are formed in this embodiment. As illustrated in FIG. 2 and FIG. 3, the third load transmission parts 30 are each formed along the longitudinal direction of the rear pillar 6, and are formed to connect the first load transmission part 28 and the second load transmission part 29 in the up-down direction.

Since the first load transmission part 28, the second load transmission part 29, and the third load transmission part 30 are formed as described above, the first load transmission part 28, the second load transmission part 29, and the third load transmission part 30 are formed around the opening 15, the pair of first load transmission parts 28 are formed around the opening 16, and the first load transmission part 28, the second load transmission part 29, and the third load transmission part 30 are formed around the opening 17.

The first load transmission part 28 and the second load transmission part 29 described above are configured to be capable of transmitting a load, which is inputted to the rear side inner panel 8 in the longitudinal direction of the vehicle body 1, to the vehicle body 1 side (see arrows F1 and F2, and arrows F3 and F4 illustrated in FIG. 8).

Further, the third load transmission part 30 is configured to be capable of transmitting a load (e.g., a load F5 inputted from the rear wheelhouse 11) in the up-down direction of the vehicle body 1, which is inputted to the first load transmission part 28 and the second load transmission part 29, to the vehicle body 1 side (see arrows F6 and F7 illustrated in FIG. 8).

The “load in the up-down direction of the vehicle body 1” described above is, for example, a load that is inputted when the vehicle travels on a curved road and distortion in the up-down direction occurs.

Next, actions and effects obtained by the vehicle body rear part structure according to this embodiment will be described.

According to this embodiment, since the rear side inner panel 8 arranged from the rear wheelhouse 11 to the rear pillar 6 is provided with the skeleton part 14 extending in the front-rear direction of the vehicle body 1, it is possible to suppress film surface deformation of the rear side inner panel 8 and suppress occurrence of vibration of the rear side inner panel 8 and noise caused by this vibration. Further, since the skeleton part 14 enables load transmission between the rear wheelhouse 11 and the rear pillar 6, the rigidity of the rear side inner panel 8 can be improved. Therefore, vibration of the rear side inner panel 8 and noise caused by this vibration can be suppressed while ensuring the rigidity of the rear side inner panel 8.

Further, according to this embodiment, since it is possible to suppress film surface deformation of the rear side inner panel 8 without using a reinforcing member such as a bracket by forming the cross-sectional shape of the skeleton part 14 when cut perpendicularly to the longitudinal direction of the skeleton part 14 to protrude toward the vehicle width direction (vehicle width direction outer side in this embodiment), it is possible to suppress occurrence of vibration of the rear side inner panel 8 and noise caused by this vibration without using a reinforcing member. Further, since the skeleton part 14 enables load transmission between the rear wheelhouse 11 and the rear pillar 6, the rigidity of the rear side inner panel 8 can be improved. Therefore, vibration of the rear side inner panel 8 and noise caused by this vibration can be suppressed while ensuring the rigidity of the rear side inner panel 8.

Further, according to this embodiment, since the skeleton part 14 is provided to extend in the front-rear direction of the vehicle body 1 along the lower end part of the window 10, by configuring the skeleton part 14 along the lower end part of the window 10, it is possible to improve the rigidity around the window 10 which forms an opening, and it is possible to effectively suppress film surface deformation of the rear side inner panel 8. Therefore, vibration of the rear side inner panel 8 and noise caused by this vibration can be further suppressed while ensuring the rigidity of the rear side inner panel 8.

Further, according to this embodiment, since the cross-sectional depth of the skeleton part 14 when cut in the vehicle width direction along the longitudinal direction of the skeleton part 14 is formed to increase toward the longitudinal middle part of the skeleton part 14, a load inputted to the rear side inner panel 8 can be efficiently transmitted to the skeleton part 14, and the rigidity of the rear side inner panel 8 can be further improved. As a result, it is possible to further suppress film surface deformation of the rear side inner panel 8 and suppress occurrence of vibration of the rear side inner panel 8 and noise caused by this vibration. Therefore, vibration of the rear side inner panel 8 and noise caused by this vibration can be further suppressed while ensuring the rigidity of the rear side inner panel 8.

Further, according to this embodiment, since the skeleton part 14 connects the quarter pillar 5 and the rear pillar 6, a load inputted to the rear side inner panel 8 can be transmitted to the quarter pillar 5 and the rear pillar 6 via the skeleton part 14, and the rigidity of the rear side inner panel 8 can be improved. As a result, it is possible to further suppress film surface deformation of the rear side inner panel 8 and suppress occurrence of vibration of the rear side inner panel 8 and noise caused by this vibration. Therefore, vibration of the rear side inner panel 8 and noise caused by this vibration can be further suppressed while ensuring the rigidity of the rear side inner panel 8.

Further, according to this embodiment, since the load transmission part 18 is provided around each of the plurality of openings 15, 16, and 17 provided at the rear side inner panel 8, an inputted load can be transmitted via the load transmission part 18 while reducing the weight of the rear side inner panel 8. As a result, it is possible to reduce the weight of the rear side inner panel 8 while ensuring the rigidity of the rear side inner panel 8.

Further, according to this embodiment, since the first load transmission part 28 is provided to extend from the upper end part 31 and the lower end part 32 of the rear wheelhouse 11 toward the longitudinal middle part side of the rear pillar 6, a load inputted to the rear side inner panel 8 can be efficiently transmitted, and the rigidity of the rear side inner panel 8 can be improved. As a result, it is possible to further suppress film surface deformation of the rear side inner panel 8 and suppress occurrence of vibration of the rear side inner panel 8 and noise caused by this vibration. Therefore, vibration of the rear side inner panel 8 and noise caused by this vibration can be further suppressed while ensuring the rigidity of the rear side inner panel 8.

Further, according to this embodiment, by providing the second load transmission part 29 extending respectively from the upper end part 31 and the lower end part 32 of the rear wheelhouse 11 to the upper end part 33 and the lower end part 34 of the rear pillar 6, a load inputted to the rear side inner panel 8 can be efficiently transmitted, and the rigidity of the rear side inner panel 8 can be improved. As a result, it is possible to further suppress film surface deformation of the rear side inner panel 8 and suppress occurrence of vibration of the rear side inner panel 8 and noise caused by this vibration. Therefore, vibration of the rear side inner panel 8 and noise caused by this vibration can be further suppressed while ensuring the rigidity of the rear side inner panel 8.

Further, according to this embodiment, by providing the third load transmission part 30 which connects the first load transmission part 28 and the second load transmission part 29, not only a load inputted in the front-rear direction of the vehicle body 1, but also a load in the up-down direction of the vehicle body 1 inputted to the first load transmission part 28 and the second load transmission part 29 can be transmitted. As a result, deformation of the first load transmission part 28 and the second load transmission part 29 can be suppressed. Therefore, vibration of the rear side inner panel 8 and noise caused by this vibration can be further suppressed while ensuring the rigidity of the rear side inner panel 8.

The configurations described in the above embodiment can be appropriately modified within the scope of the disclosure and are not limited to the configurations of the above embodiment.

In the above-described embodiment, the skeleton part 14 is formed to protrude toward the vehicle width direction outer side from the main body part 9. However, the configuration is not limited thereto but may be a configuration below.

That is, although not shown, the skeleton part may be formed to protrude toward the vehicle width direction inner side from the main body part of the rear side inner panel. In this case, the skeleton part is formed so that the cross-sectional shape when cut perpendicularly to the longitudinal direction of the skeleton part protrudes (substantially U-shape) toward the vehicle width direction inner side.

According to the above configuration, since it is possible to suppress film surface deformation of the rear side inner panel without using a reinforcing member such as a bracket by forming the cross-sectional shape of the skeleton part when cut perpendicularly to the longitudinal direction of the skeleton part to protrude toward the vehicle width direction inner side, it is possible to suppress occurrence of vibration of the rear side inner panel and noise caused by this vibration without using a reinforcing member. Further, since the skeleton part enables load transmission between the rear wheelhouse and the rear pillar, it is possible to improve the rigidity of the rear side inner panel.

Therefore, according to the above configuration, similar to the above embodiment, it is possible to suppress vibration of the rear side inner panel and noise caused by this vibration while ensuring the rigidity of the rear side inner panel.

What is claimed is:

1. A vehicle body rear part structure comprising a rear side inner panel which forms a part of a rear wheelhouse, wherein the rear side inner panel constitutes a part of an opening provided at a vehicle body rear part and is joined to a rear pillar extending in an up-down direction of a vehicle body, and
the rear side inner panel comprises a skeleton part extending in a front-rear direction of the vehicle body.

2. The vehicle body rear part structure according to claim 1, wherein
the skeleton part is formed so that a cross-sectional shape when cut perpendicularly to a longitudinal direction of the skeleton part protrudes in a vehicle width direction.

3. The vehicle body rear part structure according to claim 2, wherein
a window is formed at a side part of the vehicle body rear part by the vehicle body and the rear side inner panel, and
the skeleton part extends in the front-rear direction of the vehicle body along a lower end part of the window.

4. The vehicle body rear part structure according to claim 3, wherein
the skeleton part is formed so that a cross-sectional depth of the skeleton part when cut in the vehicle width direction along the longitudinal direction of the skeleton part increases toward a longitudinal middle part of the skeleton part.

5. The vehicle body rear part structure according to claim 3, wherein
the rear side inner panel is integrally formed with a wheelhouse outer which constitutes a vehicle width direction outer side of the rear wheelhouse,
the rear wheelhouse comprises a wheelhouse inner which constitutes a vehicle width direction inner side of the rear wheelhouse,
a lower end part of a quarter pillar extending in the up-down direction of the vehicle body is connected to an upper end part side of the wheelhouse inner, and the quarter pillar is arranged at a predetermined interval with the rear pillar in the front-rear direction of the vehicle body, and
the skeleton part extends from the quarter pillar to the rear pillar.

6. The vehicle body rear part structure according to claim 1, wherein
the rear side inner panel comprises a plurality of openings, and comprises a plurality of load transmission parts formed around each of the openings.

7. The vehicle body rear part structure according to claim 6, wherein
the load transmission parts comprise a first load transmission part extending from an upper end part and a lower end part of the rear wheelhouse toward a longitudinal middle part side of the rear pillar.

8. The vehicle body rear part structure according to claim 7, wherein
the load transmission parts comprise a pair of second load transmission parts, and
one of the second load transmission parts extends from the upper end part of the rear wheelhouse to an upper end part of the rear pillar, and another of the second load transmission parts extends from the lower end part of the rear wheelhouse to a lower end part of the rear pillar.

9. The vehicle body rear part structure according to claim 8, wherein
the load transmission parts comprise a third load transmission part which is formed along a longitudinal direction of the rear pillar and connects the first load transmission part and the second load transmission parts.
